(19) United States
(12) Patent Application Publication
(10) Pub. No.: US 2016/0082974 A1
(43) Pub. Date: Mar. 24, 2016

(54) APPARATUS AND METHOD OF ROAD SLOPE ESTIMATING BY USING GRAVITATIONAL ACCELERATION SENSOR

(71) Applicants: HYUNDAI MOTOR COMPANY, Seoul (KR); Kia Motors Corporation, Seoul (KR)

(72) Inventors: Dong Hoon JEONG, Osan-si (KR); Byeong Wook JEON, Seoul (KR)

(21) Appl. No.: 14/559,800

(22) Filed: Dec. 3, 2014

(30) Foreign Application Priority Data
Sep. 22, 2014 (KR) 10-2014-0126180

(51) Int. Cl. B60W 40/076; G01P 15/00; G01C 9/00

(52) U.S. Cl. CPC B60W 40/076; G01C 9/00; G01P 15/00

(57) ABSTRACT

A method of road slope estimating by using a gravitational acceleration sensor includes determining whether a condition of estimating the road slope by using the gravitational acceleration sensor is satisfied; estimating the road slope by using the gravitational acceleration sensor and updating the road slope when a condition of estimating the road slope by the gravitational acceleration sensor is satisfied; comparing a change rate of the estimated road slope with a first predetermined value; comparing a difference between the estimated road slope and a filtered road slope with a second predetermined value when the change rate of the estimated road slope is greater than or equal to the first predetermined value; and filtering the estimated road slope by changing a coefficient of the filter when the difference between the estimated road slope and the filtered road slope is greater than or equal to the second predetermined value.

### CROSS-REFERENCE TO RELATED APPLICATION

This application claims priority to and the benefits of Korean Patent Application No. 10-2014-0126180 filed in the Korean Intellectual Property Office on Sep. 22, 2014, the entire contents of which are incorporated herein by reference.

### TECHNICAL FIELD

The present inventive concept relates to an apparatus and a method of road slope estimating by using a gravitational acceleration sensor. More particularly, the present inventive concept relates to an apparatus and a method of road slope estimating by using a gravitational acceleration sensor that distinguishes between pitching of a vehicle and a road slope and correctly estimates the road slope by changing a coefficient of a low pass filter according to change rate of the road slope.

### BACKGROUND

Generally, methods of estimating a road slope are classified into a method using a driving torque and a method using a gravitational acceleration sensor.

A load of the vehicle changes depending on a road slope, so an increase rate of a vehicle speed regarding the driving torque is changed according to the road slope. Thus, the method of estimating a road slope by using the driving torque estimates road the slope by using a difference of the increase rate of the vehicle speed. The method of estimating a road slope by using the driving torque can estimate the road slope without an additional sensor. However, the method of estimating a road slope by using the driving torque cannot correctly estimate the road slope due to change of the driving torque. Thus, an excessive error of the road slope occurs due to a change of the driving torque. Moreover, the method of estimating a road slope by using the driving torque cannot distinguish a load of the road slope from a load of carrying freight or towing.

On the other hand, the method of estimating a road slope by using the gravitational acceleration sensor detects a longitudinal acceleration when the vehicle is located on a slope. Thus, the method of estimating a road slope by using the gravitational acceleration sensor calculates a pitching slope of the vehicle by comparing the longitudinal acceleration with the increase rate of the vehicle speed. Since the pitching slope is the road slope if wheels of the vehicle have a fixed height, the method of estimating a road slope by using the gravitational acceleration sensor can estimate the road slope regardless of the driving torque. Also, the method of estimating a road slope by using the gravitational acceleration sensor can estimate the road slope even though the vehicle carries freight or is towed.

The method of estimating a road slope by using the gravitational acceleration sensor has a high accuracy and a fast responsiveness compared to the method of estimating the road slope by using the driving torque. However, the gravitational acceleration sensor outputs a high frequency noise due to a rough road and acceleration according to a pitching slope of the vehicle. Thus, the method of estimating a road slope by using the gravitational acceleration sensor should use a low pass filter in order to reduce noise.

In that case, if the low pass filter is used, a delay of response may occur and the pitching slope of the vehicle cannot be distinguished from the road slope.

The above information disclosed in this Background section is only for enhancement of understanding of the background of the present inventive concept and therefore it may contain information that does not form the prior art that is already known in this country to a person of ordinary skill in the art.

### SUMMARY

The present inventive concept has been made in an effort to provide an apparatus and a method of road slope estimating by using a gravitational acceleration sensor having advantages of distinguishing between a pitching of the vehicle and a road slope and correctly estimating the road slope by changing a coefficient of a low pass filter according to change rate of the road slope.

An exemplary embodiment of the present inventive concept provides a method of road slope estimating by using a gravitational acceleration sensor that may include determining whether a condition of estimating road slope by using the gravitational acceleration sensor is satisfied; estimating the road slope by using the gravitational acceleration sensor and updating the road slope when a condition of estimating the road slope by the gravitational acceleration sensor is satisfied; filtering the estimated road slope; comparing a change rate of the estimated road slope with a first predetermined value; comparing a difference between the estimated road slope and the filtered road slope with a second predetermined value when the change rate of the estimated road slope is greater than or equal to the first predetermined value; and filtering the estimated road slope by changing a coefficient of the filter when the difference between the estimated road slope and the filtered road slope is greater than or equal to the second predetermined value.

The determination of the condition of estimating the road slope by using the gravitational acceleration sensor being satisfied may be performed when signals of the gravitational acceleration sensor and a vehicle speed sensor are valid.

The method further includes estimating the road slope by using a driving torque and updating the road slope when any one of signals of the gravitational acceleration sensor or a vehicle speed sensor is not valid.

The condition of estimating the road slope by using the gravitational acceleration sensor may be satisfied when the vehicle is not reversing, an antilock brake system (ABS) is not operating, the vehicle is not shifting, a steering angle is smaller than a predetermined angle, a speed difference between wheels of the vehicle is smaller than a predetermined speed, a change rate of an accelerator pedal is smaller than a first predetermined change rate, and a change rate of a brake pedal is smaller than a second predetermined change rate.

The method includes stopping the estimation of road slope by using the gravitational acceleration sensor; and maintaining the estimated road slope by using the gravitational acceleration sensor when the condition of estimating road slope by using the gravitational acceleration sensor is not satisfied.

The determination of the condition of estimating road slope by using the gravitational acceleration sensor being satisfied is repeatedly performed at predetermined time intervals.

The coefficient of the filter may be changed based on the change rate of the estimated road slope and the difference between the estimated road slope and the filtered road slope.

Another exemplary embodiment of the present inventive concept provides an apparatus of road slope estimating by using a gravitational acceleration sensor that may include a gravitational acceleration sensor configured to detect a horizontal acceleration and a longitudinal acceleration of a vehicle; a data detector configured to detect data for estimating the road slope by using the gravitational acceleration sensor; and a controller configured to estimate the road slope and filter the estimated road slope when a condition of estimating the road slope by using the gravitational acceleration sensor is satisfied, and filter the estimated road slope again by changing a coefficient based on a change rate of the estimated road slope or a difference between the estimated road slope and the filtered road slope.

The detected data may include information on at least one of a vehicle speed, an acceleration of the vehicle, a position of an accelerator pedal, a position of a brake pedal, a shift gear of the vehicle, a wheel speed of the vehicle, and a steering angle of the vehicle.

The condition of estimating the road slope by using the gravitational acceleration sensor may be satisfied when the vehicle is not reversing, an antilock brake system (ABS) is not operating, the vehicle is not shifting, a steering angle is smaller than a predetermined angle, a speed difference between wheels of the vehicle is smaller than a predetermined speed, a change rate of an accelerator pedal is smaller than a first predetermined change rate, and a change rate of a brake pedal is smaller than a second predetermined change rate.

The controller is configured to stop the estimation of the road slope by using the gravitational acceleration sensor and maintain the estimated road slope by using the gravitational acceleration sensor when the condition of estimating the road slope by using the gravitational acceleration sensor is not satisfied.

The controller is configured to repeatedly determine whether the condition of estimating the road slope by using the gravitational acceleration sensor is satisfied at predetermined time intervals.

The controller is configured to determine whether the condition of estimating the road slope by using the gravitational acceleration sensor is satisfied when signals of the gravitational acceleration sensor and a vehicle speed sensor are valid.

The controller is configured to estimate road slope by using a driving torque when any one of signals of the gravitational acceleration sensor or of a vehicle speed sensor is not valid.

As described above, according to an exemplary embodiment of the present inventive concept, a pitching slope of the vehicle can be distinguished from the road slope depending on the condition of estimating the road slope by using the gravitational acceleration sensor, so the road slope can be estimated correctly.

In addition, the coefficient of the low pass filter is changed based on the change rate of road slope, so responsiveness and precision of estimating the road slope can be improved.

### BRIEF DESCRIPTION OF THE DRAWINGS

FIG. 1 is a block diagram of an apparatus for estimating a road slope by using a gravitational acceleration sensor according to an exemplary embodiment of the present inventive concept.

FIG. 2 is a drawing illustrating an estimating principle of a road slope by using a gravitational acceleration sensor according to an exemplary embodiment of the present inventive concept.

FIG. 3 is a flowchart of a method of estimating a road slope by using a gravitational acceleration sensor according to an exemplary embodiment of the present inventive concept.

FIG. 4 is a flowchart of a method of determining whether a condition of estimating the road slope by using the gravitational acceleration sensor is satisfied according to an exemplary embodiment of the present inventive concept.

FIG. 5 is a graph showing a result of estimating a road slope by using a gravitational acceleration sensor according to an exemplary embodiment of the present inventive concept.

### DETAILED DESCRIPTION OF THE DRAWINGS

In the following detailed description, only certain exemplary embodiments of the present inventive concept have been shown and described, simply by way of illustration. As those skilled in the art would realize, the described embodiments may be modified in various different ways, all without departing from the spirit or scope of the present inventive concept.

Throughout this specification and the claims which follow, unless explicitly described to the contrary, the word “comprise” and variations such as “comprises” or “comprising” will be understood to imply the inclusion of stated elements but not the exclusion of any other elements. Like reference numerals designate like elements throughout the specification.

An exemplary embodiment of the present inventive concept will hereinafter be described in detail with reference to the accompanying drawings.

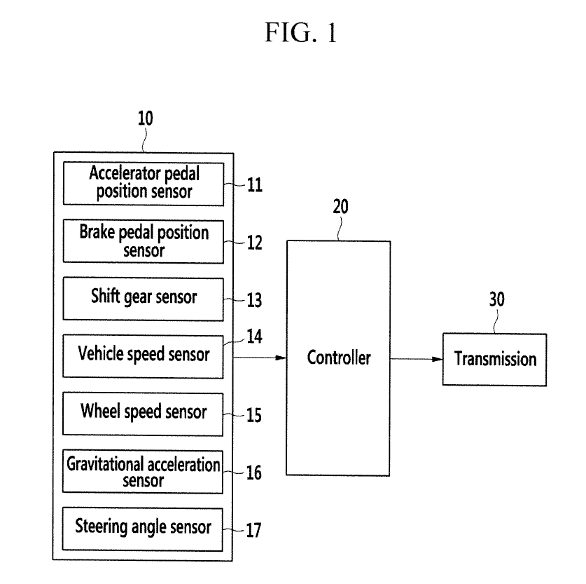

FIG. 1 is a block diagram of an apparatus for estimating a road slope by using a gravitational acceleration sensor according to an exemplary embodiment of the present inventive concept.

As shown in FIG. 1, an apparatus for estimating a road slope by using a gravitational acceleration sensor according to an exemplary embodiment of the present inventive concept includes a data detector 10, a controller 20, and a transmission 30.

The data detector 10 detects data related to a road slope estimation for determining a driving state of the vehicle and controlling a shift of the vehicle, and the data detected by the data detector 10 is transmitted to the controller 30. The data detector 10 includes an accelerator pedal position sensor 11, a brake pedal position sensor 12, a shift gear sensor 13, a vehicle speed sensor 14, a wheel speed sensor 15, a gravitational acceleration sensor 16, and a steering angle sensor 17.

The accelerator pedal position sensor 11 detects a degree at which a driver pushes an accelerator pedal. A position value of the accelerator pedal may be 100% when the accelerator pedal is pressed fully, and the position value of the accelerator pedal may be 0% when the accelerator pedal is not pressed at all. That is, the accelerator pedal position sensor 11 detects data related to a driver's acceleration will.

The brake pedal position sensor 12 detects whether a brake pedal is pushed or not. A position value of the brake pedal may be 100% when the brake pedal is pressed fully, and the position value of the brake pedal may be 0% when the brake pedal is not pressed at all. That is, the brake pedal position sensor 12 detects the driver's acceleration will in cooperation with the accelerator pedal position sensor 11.

The shift gear sensor 13 detects a shift gear stage that is currently engaged.

The vehicle speed sensor 14 detects a vehicle speed, and is mounted at a wheel of the vehicle. Alternatively, the vehicle speed may be calculated based on a signal received by the wheel speed sensor 15.

Meanwhile, a target shift-speed may be calculated by using a shift pattern based on the signal of the accelerator pedal position sensor 11 and the signal of the vehicle speed sensor 14, and the shift to the target shift-speed is thereby controlled. That is, a hydraulic pressure supplied to a plurality of friction elements or released from a plurality of friction elements is controlled in an automatic transmission provided with a plurality of planetary gear sets and the plurality of friction elements. In addition, currents applied to a plurality of synchronizer devices and actuators are controlled in a double clutch transmission.

The wheel speed sensor 15 detects a wheel rotation speed of the vehicle, and is mounted at a wheel of the vehicle. The wheel speed sensor 15 controls a brake hydraulic pressure when the wheel of the vehicle slips according to quick braking.

The gravitational acceleration sensor 16 detects an acceleration of the vehicle. The gravitational acceleration sensor 16 may be mounted in addition to the vehicle speed sensor 14 and may directly detect the acceleration of the vehicle, or the gravitational acceleration sensor 16 may calculate the acceleration of the vehicle by differentiating the vehicle speed detected by the vehicle speed sensor 14. Moreover, the gravitational acceleration sensor 16 may detect a longitudinal acceleration when the vehicle is located on a slope.

The steering angle sensor 17 detects a steering angle of the vehicle. That is, the steering angle sensor 17 detects a direction in which the vehicle runs.

The controller 20 controls the transmission 30 based on information output from the data detector 10.

The controller 20 determines whether a condition of estimating the road slope by using the gravitational acceleration sensor is satisfied when signals of the gravitational acceleration sensor 16 and a vehicle speed sensor 14 detected by the data detector 10 are valid. The controller 20 may repeatedly determine whether the condition of estimating the road slope by using the gravitational acceleration sensor is satisfied at predetermined time intervals. Alternatively, the controller 20 estimates road slope by using the driving torque when any one of signals of the gravitational acceleration sensor 16 or a vehicle speed sensor 14 detected by the data detector is not valid.

The controller 20 estimates road slope and filters the estimated road slope when the condition of estimating the road slope by using the gravitational acceleration sensor is satisfied. After that, the controller 20 may filter again by changing a coefficient of the filter based on a change rate of the estimated road slope or a difference between the estimated road slope and the filtered road slope.

On the other hand, the controller 20 stops the estimation of road slope by using the gravitational acceleration sensor and maintains the estimated road slope by using the gravitational acceleration sensor when the condition of estimating the road slope by using the gravitational acceleration sensor is not satisfied.

The controller 20 is configured to change a shift pattern, engaging feeling to the target shift-speed, an engine torque map and/or an engine torque filter according to the estimated road slope.

For these purposes, the controller 20 may be implemented as at least one processor that is operated by a predetermined program, and the predetermined program may be programmed in order to perform each step of a method of estimating the road slope by using the gravitational acceleration sensor according to an exemplary of the present inventive concept.

Various embodiments described herein may be implemented within a recording medium that may be read by a computer or a similar device by using software, hardware, or a combination thereof, for example.

According to hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units designed to perform any other functions.

According to software implementation, embodiments such as procedures and functions described in the present embodiments may be implemented by separate software modules. Each of the software modules may perform one or more functions and operations described in the present inventive concept. A software code may be implemented by a software application written in an appropriate program language.

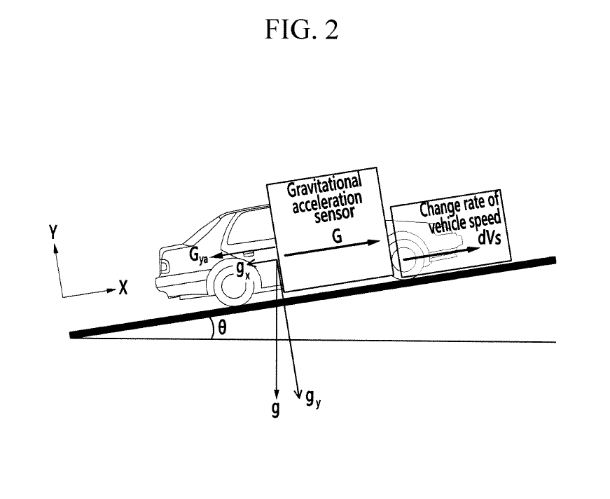

FIG. 2 is a drawing illustrating an estimating principle of a road slope by using a gravitational acceleration sensor according to an exemplary embodiment of the present inventive concept.

The controller 20 is configured to estimate the road slope by using the gravitational acceleration sensor according to the principle illustrated in FIG. 2, but it is not limited thereto.

Referring to FIG. 2, the road slope may be calculated from the following equation.

Road slope (%)=tan θ*100=k*(G−dVs)

Here, an angle θ indicates a slope of the vehicle on a road, and includes an installation angle of the gravitational acceleration sensor. The variable “G” indicates progress direction (horizontal) acceleration of the vehicle, and the variable “dVs” indicates a change rate of the vehicle speed.

The variable G may be calculated from the equation below.

G=dVs+gx=dVs+g sin θ

In addition, the variable “k” may be calculated from the equation below.

$$k = \frac{1}{g \sqrt{1 - {sin}^{2} θ}}$$

In the above equation, g indicates gravity acceleration of the vehicle.

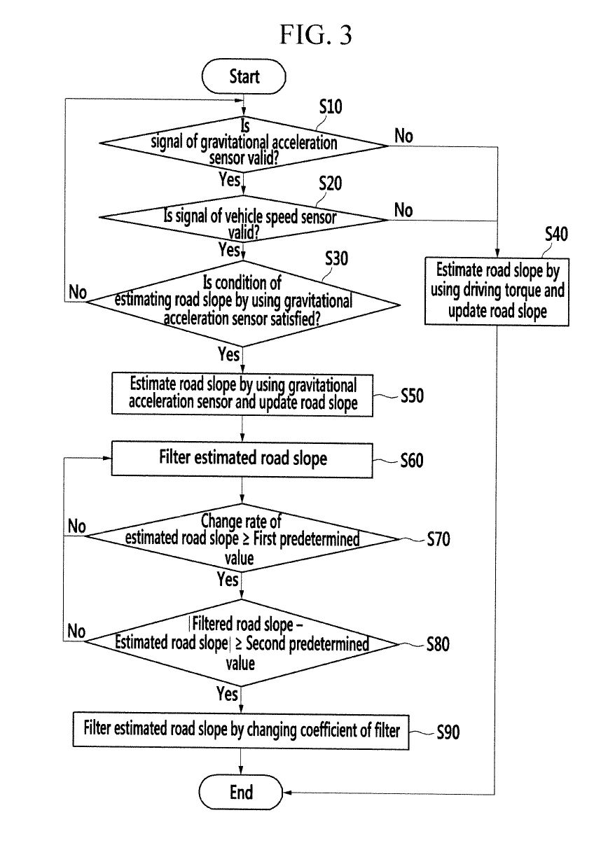

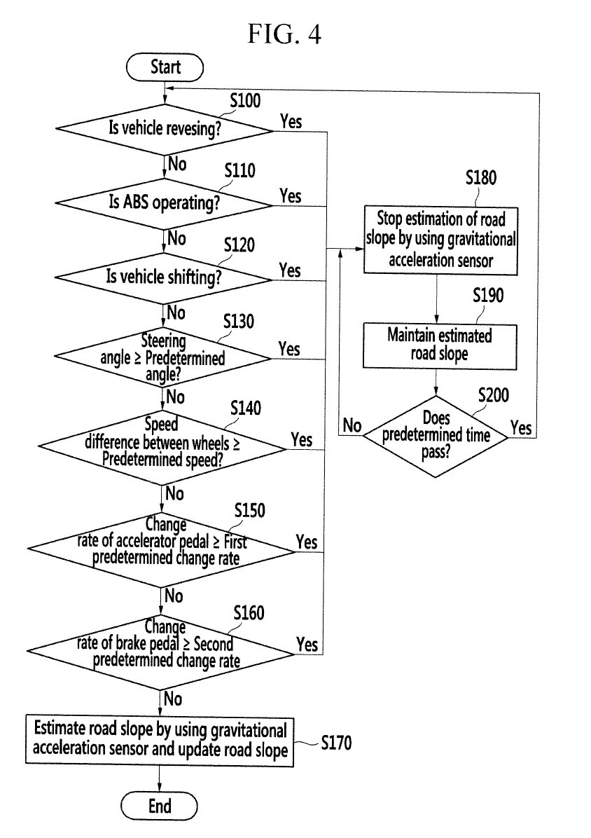

Hereinafter, a method of estimating the road slope by using the gravitational acceleration sensor according to an exemplary embodiment of the present inventive concept will be described in detail with reference to FIG. 3 and to FIG. 4.

FIG. 3 is a flowchart of a method of estimating a road slope by using a gravitational acceleration sensor according to an exemplary embodiment of the present inventive concept.

As shown in FIG. 3, a method of estimating a road slope by using a gravitational acceleration sensor according to an exemplary embodiment of the present inventive concept starts with determining whether a signal of the gravitational acceleration sensor is valid, at step S10.

When the signal of the gravitational acceleration sensor is determined to be valid, the controller 20 determines whether a signal of the vehicle speed sensor 14 is valid, at step S20.

The estimation of the road slope by using the gravitational acceleration sensor is available when the signals of the gravitational acceleration sensor 16 and the vehicle speed sensor 14 are both valid. Therefore, the controller 20 determines whether the condition of estimating road slope by using the gravitational acceleration sensor 16 is satisfied when the signals of the gravitational acceleration sensor 16 and the vehicle speed sensor 14 are both valid, at step S30.

Otherwise, the controller 20 estimates the road slope by using a driving torque and updates the road slope when any one of signals of the gravitational acceleration sensor or the vehicle speed sensor 14 is not valid, at step S40.

If the estimation of the road slope by using the gravitational acceleration sensor 16 is impossible when a problem of the gravitational acceleration sensor 16 or the vehicle speed sensor 14 occurs, the controller 20 is configured to substitute the road slope by estimating the road slope by using a driving torque and updating the road slope.

The method of determining whether the condition of estimating the road slope by using the gravitational acceleration sensor 16, which is performed at step S30, is illustrated in FIG. 4.

FIG. 4 is a flowchart of a method of determining whether a condition of estimating the road slope by using the gravitational acceleration sensor 16 is satisfied according to an exemplary embodiment of the present inventive aspect.

Referring to FIG. 4, the controller 20 determines whether the vehicle is reversing in order to determine the condition of estimating the road slope by using the gravitational acceleration sensor 16, at step S100.

The estimating principle of the road slope by using the gravitational acceleration sensor 16 illustrated in FIG. 2 may be applied when the vehicle drives forward. If the vehicle is reversing, a sign of the road slope would be negative. Thus, the controller 20 maintains the estimated road slope when the vehicle is reversing.

After that, the controller 20 determines whether an antilock brake system (ABS) of the vehicle is operating, at step S110. For example, when the ABS is operated due to a wheel slip of the vehicle, an acceleration value detected by the gravitational acceleration sensor 16 may be zero (“0”) since a grip force of a tire of the vehicle is 0. Thus, the controller 20 maintains the estimated road slope when the ABS is operating.

Moreover, the controller 20 determines whether the vehicle is shifting gears, at step S120. For example, the acceleration value detected by the gravitational acceleration sensor 16 may be changed due to a change of gear ratio or a shift shock when the vehicle is shifting. Thus, the controller 20 maintains the estimated road slope when the vehicle is shifting gears.

After that, the controller 20 deter mines whether a steering angle is greater than or equal to a predetermined angle, at step S130. For example, a difference between the acceleration value detected by the gravitational acceleration sensor 16 and a longitudinal acceleration value calculated by a change rate of the wheel speed may be generated when the vehicle swirls due to the steering. Thus, the controller 20 maintains the estimated road slope when the steering angle is greater than or equal to the predetermined angle.

In addition, the controller 20 determines whether a speed difference between wheels of the vehicle is greater than or equal to a predetermined speed, at step S140. For example, the speed difference between wheels of the vehicle may be generated when a wheel slip occurs or the vehicle swirls. Thus, the controller 20 maintains the estimated road slope when the speed difference between wheels of the vehicle is greater than or equal to the predetermined speed.

After that, the controller 20 determines whether a change rate of an accelerator pedal is greater than or equal to a first predetermined change rate, at step S150. For example, a pitching motion of the vehicle may be generated when an output of the engine is changed due to the change rate of the accelerator pedal. Thus, the controller 20 maintains the estimated road slope when the change rate of the accelerator pedal is greater than or equal to the first predetermined change rate.

In addition, the controller 20 determines whether a change rate of a brake pedal is greater than or equal to a second predetermined change rate, at step S160. For example, the pitching motion of the vehicle may be generated when a braking force is changed due to the change rate of the brake pedal. Thus, the controller 20 maintains the estimated road slope when the change rate of the brake pedal is greater than or equal to the second predetermined change rate.

The controller 20 determines that the condition of estimating road slope by using the gravitational acceleration sensor 16 is satisfied when the vehicle is not reversing, the ABS is not operating, the vehicle is not shifting, the steering angle is smaller than a predetermined angle, the speed difference between wheels of the vehicle is smaller than a predetermined speed, the change rate of an accelerator pedal is smaller than a first predetermined change rate, and a change rate of a brake pedal is smaller than a second predetermined change rate, as determined from step S110 to step S160. Then, the controller 20 estimates the road slope by using the gravitational acceleration sensor 16 and updates the road slope, at step S170.

On the other hand, the controller 20 stops the estimation of the road slope by using the gravitational acceleration sensor 16, at step S180 and maintains the estimated road slope by using the gravitational acceleration sensor 16, at step S190, when the condition of estimating the road slope by using the gravitational acceleration sensor 16 is not satisfied, as determined from t step S110 to step S160.

After that, the controller 20 determines whether the condition of estimating road slope by using the gravitational acceleration sensor 16 is satisfied, as determined from step S110 to t step S160, again after a lapse of a predetermined time, at step S200. For example, the condition of estimating road slope by using the gravitational acceleration sensor 16 may be satisfied if the pitching motion of the vehicle is decreased after the lapse of the predetermined time.

When the condition of estimating road slope by using the gravitational acceleration sensor is satisfied, as determined from step S110 to t step S160, the controller 20 estimates the road slope by using the gravitational acceleration sensor 16 and updates the road slope, at step S50 of FIG. 3. When the road slope is estimated by using the gravitational acceleration sensor 16, at t step S50, the controller 20 filters the estimated road slope, at step S60.

The filter, used for the estimation of the road slope performed at step S60, may be a low pass filter that reduces high frequency noise, but it is not limited thereto. The low pass filter may remove high frequency noise due to a vibration of the vehicle or a rough road.

The controller 20 compares a change rate of the estimated road slope estimated with a first predetermined value, at step S70. That is, the controller 20 compares the change rate of the estimated road slope before filtering with the first predetermined value. The high frequency noise may be increased as the change rate of the estimated road slope before filtering is larger.

When the change rate of the estimated road slope is determined to be greater than or equal to the first predetermined value, at step S70, the controller 20 compares a difference between the estimated road slope and the filtered road slope with a second predetermined value, at step S80. The high frequency noise may be increased by the pitching motion of the vehicle as the difference between the estimated road slope and the filtered road slope is larger. For example, the pitching motion of the vehicle may occur when the vehicle passes over a speed bump.

When the change rate of the estimated road slope is determined to be greater than or equal to the first predetermined value, at step S70, and the difference between the estimated road slope and the filtered road slope is determined to be greater than or equal to the second predetermined value, at step S80, the controller 20 changes a coefficient of the filter and filters the estimated road slope again with the changed filter, at step S90.

The coefficient of the filter may be a time constant of the low pass filter, but it is not limited thereto. The coefficient of the filter may be changed in accordance with the change rate of the estimated road slope or the difference between the estimated road slope and the filtered road slope. That is, the coefficient of the filter may become smaller as the change rate of the estimated road slope or the difference between the estimated road slope and the filtered road slope is larger in order to lower a cutoff frequency, but it is not limited thereto.

If the filter as described above is applied, an evaluation of the road slope is improved compared with applying a conventional filter which has a fixed coefficient.

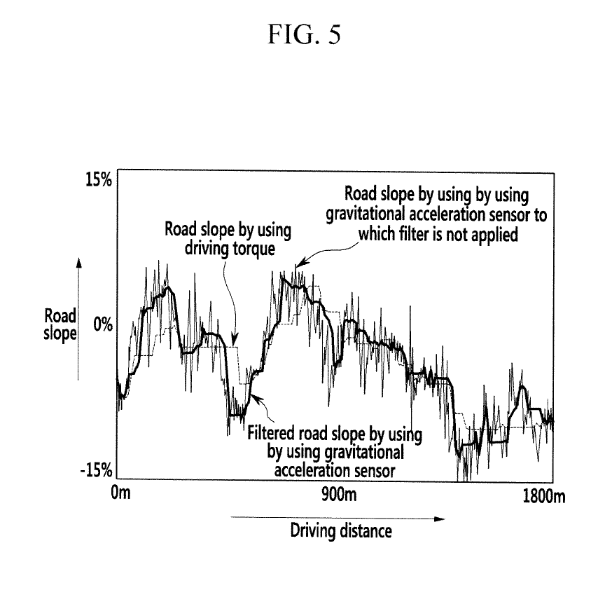

FIG. 5 is a graph showing a result of estimating a road slope by using a gravitational acceleration sensor according to an exemplary embodiment of the present invention.

FIG. 5 is a graph that compares the road slope estimated by using the gravitational acceleration sensor 16 according to an exemplary embodiment of the present inventive concept, the road slope by using the gravitational acceleration sensor 16 according to conventional arts, and road slope estimated by using the driving torque when the vehicle drives on a road of which a gradient is changed.

The road slope estimated by using the driving torque is relatively accurate, but has slowest responsiveness. The road slope found by using the gravitational acceleration sensor 16 according to conventional arts has fast responsiveness, but it is incorrect due to a lot of noise. Contrary to this, the road slope estimated by using the gravitational acceleration sensor 16 according to an exemplary embodiment of the present inventive concept has fast responsiveness, and is accurate because of reducing noise.

While this inventive concept has been described in connection with what is presently considered to be practical exemplary embodiments, it is to be understood that the inventive concept is not limited to the disclosed embodiments. On the contrary, it is intended to cover various modifications and equivalent arrangements included within the spirit and scope of the appended claims.

What is claimed is:

1. A method of road slope estimating by using a gravitational acceleration sensor, comprising:
determining whether a condition of estimating the road slope by using the gravitational acceleration sensor is satisfied;
estimating the road slope by using the gravitational acceleration sensor and updating the road slope when a condition of estimating the road slope by the gravitational acceleration sensor is satisfied;
filtering the estimated road slope;
comparing a change rate of the estimated road slope with a first predetermined value;
comparing a difference between the estimated road slope and the filtered road slope with a second predetermined value when the change rate of the estimated road slope is greater than or equal to the first predetermined value; and
filtering the estimated road slope by changing a coefficient of a filter when the difference between the estimated road slope and the filtered road slope is greater than or equal to the second predetermined value.

2. The method of claim 1, wherein the determination of whether the condition of estimating road slope by using the gravitational acceleration sensor is satisfied is performed when signals of the gravitational acceleration sensor and a vehicle speed sensor are valid.

3. The method of claim 2, further comprising estimating the road slope by using a driving torque and updating the road slope when any one of signals of the gravitational acceleration sensor or of a vehicle speed sensor is not valid.

4. The method of claim 1, wherein the condition of estimating road slope by using the gravitational acceleration sensor is satisfied when the vehicle is not reversing, an antilock brake system (ABS) is not operating, the vehicle is not shifting, a steering angle is smaller than a predetermined angle, a speed difference between wheels of the vehicle is smaller than a predetermined speed, a change rate of an accelerator pedal is smaller than a first predetermined change rate, and a change rate of a brake pedal is smaller than a second predetermined change rate.

5. The method of claim 4, further comprising:
stopping the estimation of road slope by using the gravitational acceleration sensor; and
maintaining the estimated road slope by using the gravitational acceleration sensor when the condition of estimating road slope by using the gravitational acceleration sensor is not satisfied.

6. The method of claim 5, wherein the determination of whether the condition of estimating the road slope by using the gravitational acceleration sensor is satisfied is repeatedly performed at predetermined time intervals.

7. The method of claim I, wherein the coefficient of the filter is changed based on the change rate of the estimated road slope.

8. The method of claim 1, wherein the coefficient of the filter is changed based on the difference between the estimated road slope and the filtered road slope.

9. An apparatus of road slope estimating by using a gravitational acceleration sensor, comprising:
a gravitational acceleration sensor configured to detect a horizontal acceleration and a longitudinal acceleration of a vehicle;
a data detector configured to detect data for estimating the road slope by using the gravitational acceleration sensor; and
a controller configured to estimate the road slope and filter the estimated road slope when a condition of estimating the road slope by using the gravitational acceleration sensor is satisfied, and filter the estimated road slope again by changing a coefficient of a filter based on a change rate of the estimated road slope or a difference between the estimated road slope and the filtered road slope.

10. The apparatus of claim 9, wherein the data includes information on at least one of a vehicle speed, an acceleration of the vehicle, a position of an accelerator pedal, a position of a brake pedal, a shift gear of the vehicle, a wheel speed of the vehicle, and a steering angle of the vehicle.

11. The apparatus of claim 9, wherein the condition of estimating the road slope by using the gravitational acceleration sensor is satisfied when the vehicle is not reversing, an antilock brake system (ABS) is not operating, the vehicle is not shifting, a steering angle is smaller than a predetermined angle, a speed difference between wheels of the vehicle is smaller than a predetermined speed, a change rate of an accelerator pedal is smaller than a first predetermined change rate, and a change rate of a brake pedal is smaller than a second predetermined change rate.

12. The apparatus of claim 9, wherein the controller stops the estimation of the road slope by using the gravitational acceleration sensor and maintains the estimated road slope by using the gravitational acceleration sensor when the condition of estimating road slope by using the gravitational acceleration sensor is not satisfied.

13. The apparatus of claim 12, wherein the controller repeatedly determines whether the condition of estimating the road slope by using the gravitational acceleration sensor is satisfied at predetermined time intervals.

14. The apparatus of claim 9, wherein the controller determines whether the condition of estimating road slope by using the gravitational acceleration sensor is satisfied when signals of the gravitational acceleration sensor and a vehicle speed sensor are valid.

15. The apparatus of claim 14, wherein the controller estimates the road slope by using a driving torque when any one of signals of the gravitational acceleration sensor or of a vehicle speed sensor is not valid.
